(19) United States
(12) Patent Application Publication
(10) Pub. No.: US 2014/0122330 A1
(43) Pub. Date: May 1, 2014

(54) System And Method For Providing Recovery For Victims Of Checking Account Fraud

(71) Applicant: EZSHIELD, INC., Palo Alto, CA (US)

(72) Inventors: Laura Bruck, Bel Air, MD (US); Broc Silberzahn, Towson, MD (US); Erick K. Ong, Burlingame, CA (US); Carolyn Holliday, Baltimore, MD (US); Donald W. Darby, Palo Alto, CA (US)

(73) Assignee: EZSHIELD, INC., Palo Alto, CA (US)

(21) Appl. No.: 13/841,693

(22) Filed: Mar. 15, 2013

Related U.S. Application Data
(60) Provisional application No. 61/721,451, filed on Nov. 1, 2012.

(51) Int. Cl. G06Q 20/40

(52) U.S. Cl. CPC G06Q 20/4016
USPC 705/41; 705/39; 705/43

(57) ABSTRACT

A system and method for recovery of losses associated with unauthorized use of a financial account, and more particularly to a fraud protection system and method for enabling an individual consumer or business to recover losses due to mobile, online or offline fraud associated with a financial account including but not limited to funds removed from the financial account due to check fraud, debit and automated teller machine (ATM) card fraud, counterfeiting and the like.

### CROSS-REFERENCE TO RELATED APPLICATION

This application claims the benefit of, and priority to, U.S. Provisional Patent Application Ser. No. 61/721,451, filed on Nov. 1, 2012, entitled “SYSTEM AND METHOD FOR PROVIDING RECOVERY FOR VICTIMS OF CHECKING ACCOUNT FRAUD,” the entire disclosure of which is hereby incorporated herein by reference.

### BACKGROUND OF THE INVENTION

1. Field of the Invention

The invention disclosed herein relates generally to the recovery of losses associated with unauthorized use of a checking account, and more particularly to a fraud protection system and method for enabling an individual consumer or business to recover losses due to mobile, online or offline fraud associated with a checking account including but not limited to funds removed from the checking account due to check fraud, debit and automated teller machine (ATM) card fraud, counterfeiting and the like.

2. Background of the Prior Art

Attempted checking account fraud at commercial banks is a growing problem. Checking account fraud can be one of the most damaging financial frauds. A victim of checking account fraud can suffer not only loss of all their financial holdings, but damage to their credit report as well.

Many processes and techniques have been developed to thwart the growing problem of checking account fraud. Regarding methods for preventing fraud involving traditional physical checks, methods employing special inks, microprinting, encryption of machine-readable code, and specially designed checkbooks to disclose loss of checks have been developed. Even with the multitude of schemes to prevent incidents of checking account fraud, the continued growth indicates that most courses of action are ineffective in preventing such occurrence, such that businesses and consumers continue to lose significant funds through the ongoing checking account fraud ailment. Efforts must be directed to recovery of losses attributed to such checking account fraud.

Ordinarily, for a victim of checking account fraud to recover losses arising from such victimization, the victim must generally investigate the fraud on their own, report the fraud to their bank or financial institution to seek reimbursement, and initiate criminal and/or civil proceedings as appropriate, if necessary. Such steps are generally unfamiliar to the average person, and the apprehension of such tasks can present a barrier to entry.

Also, known systems for preventing check fraud do not protect the checking account as a whole and may not include protection of other means for accessing funds in a checking account. Check fraud protection services are typically tied to a physical check. However, financial institutions service checking accounts, not just checks, and physical checks are just one component of that account.

Accordingly, there remains a need for a simple method for a victim of checking account fraud to recover losses due to mobile, online or offline fraud associated with a checking account including but not limited to funds removed from the checking account due to check fraud, debit and automated teller machine (ATM) card fraud, counterfeiting and the like.

### SUMMARY

It is, therefore, an object of the present disclosure to enable a process for recovering losses due to checking account fraud that avoids the disadvantages of the prior art.

It is another object of the present disclosure to enable a method by which a subscriber can recover losses due to specific modes of checking account fraud. A related object is to enable a method by which a subscriber can recover losses directly from a Checking Account Protection (CAP) service provider. The term “Checking Account Protection” includes a restoration function, and Checking Account Protection can also be referred to as “Checking Account Restoration” or “Checking Account Protection and Restoration.”

Another object of the present disclosure is the provision of a reimbursement request form for reporting loss to the subscriber's CAP service provider.

Another object of the present disclosure is the provision of limited durable power of attorney by which a subscriber can assign any right of recovery arising from the fraud to the CAP service provider.

Another object of the present disclosure is the provision of a novel method for recovering losses arising from specific modes of checking account fraud.

Another object of the present disclosure is to provide Checking Account Protection in order to increase fee income from Consumers to the CAP service provider.

Another object of the present disclosure is to provide Checking Account Protection that is, in the United States of America, compliant with Part 205 of the Electronic Fund Transfer Act (15 U.S.C. 1693 et seq.) (also known as “Regulation E” or “Reg E” for short) and Uniform Commercial Code (UCC) requirements for disputed transactions, or compliant with similar provisions in other jurisdictions.

Another object of the present disclosure is to provide Checking Account Protection in order to drive customer retention and/or satisfaction.

Another object of the present disclosure is to provide Checking Account Protection in a manner that maximizes resource efficiency.

In accordance with the above objects, a system and method for a subscriber to protect against loss associated with specified forms of checking account fraud are provided. Upon purchasing checks, opening a checking account or at the time of subscription, a subscriber can, for an additional fee, subscribe to a Checking Account Protection (CAP) Program or System. The subscription will enable the subscriber to obtain reimbursement from the CAP service provider for the consumer's losses due to predetermined causes of checking account fraud. The subscriber reciprocally assigns any right of recovery from the subscriber's bank or financial institution to the CAP service provider, which can then seek reimbursement from the bank, or financial institution and institute proceedings against the fraud perpetrator.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification and the spirit and scope of the teachings herein.

The above and other features, aspects, and advantages of the present disclosure are considered in more detail, in relation to the following description of embodiments thereof shown in the accompanying drawings, where like reference numerals refer to like reference in the specification, in which:

FIG. 1 depicts a flow chart for a Checking Account Protection Transaction Workflow in accordance with an embodiment, where FIG. 1A is the left side of the flow chart and FIG. 1B is the right side of the flow chart;

FIG. 2 depicts a flow chart for a Checking Account Protection Subscription Workflow in accordance with an embodiment, where FIG. 2A is the left side of the flow chart and FIG. 2B is the right side of the flow chart;

FIG. 3 depicts one example of an insert relating to the CAP program in accordance with an embodiment;

FIG. 4 depicts another example of an insert relating to the CAP program in accordance with an embodiment;

FIG. 5 depicts a flow chart including an example of a method for restoring a checking account protected by the CAP system and method according to an embodiment;

FIG. 6 depicts an example of a checking account fraud or protection affidavit in accordance with an embodiment;

FIG. 7 depicts an example of a fraud-related expenses form in accordance with an embodiment;

FIG. 8 depicts an example of a form for collecting information regarding the fraud in accordance with an embodiment;

FIG. 9 depicts an example of a signature page which may include sworn statements, a block for a Notary Public or suitable public official to witness the Customer's signature, signature blocks and the like in accordance with an embodiment;

FIG. 10, and, separately, FIG. 11A, FIG. 11B and FIG. 11C depict examples of a legal document such as a Limited Power of Attorney, in accordance with an embodiment; and

FIG. 12 depicts a flow chart for a Checking Account Protection process in accordance with an embodiment, where FIG. 12A is a first portion of the flow chart, FIG. 12B is a second portion of the flow chart, FIG. 12C is a third portion of the flow chart and FIG. 12D is a fourth portion of the flow chart.

### DETAILED DESCRIPTION

It should be understood that this invention is not limited to the particular methodology, protocols, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities used herein should be understood as modified in all instances by the term “about.”

All publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities used herein should be understood as modified in all instances by the term “about.” The term “about” when used in connection with percentages may mean±1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

To the extent not already indicated, it will be understood by those of ordinary skill in the art that any one of the various embodiments herein described and illustrated may be further modified to incorporate features shown in any of the other embodiments disclosed herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

Embodiments of the invention summarized above may be better understood by referring to the following description, which should be read in conjunction with the accompanying drawings in which like reference numbers are used for like parts. This description of embodiments, set out below to enable one to practice implementations of the invention, is not intended to limit the embodiments, but to serve as particular examples thereof. Those skilled in the art should appreciate that they may readily use the conception and specific embodiments disclosed as a basis for modifying or designing other methods and systems for carrying out the same purposes of the present disclosure. Those skilled in the art should also realize that such equivalent assemblies do not depart from the spirit and scope of the invention in its broadest form.

It is to be noted that although the term “checking account” is used in the present specification for convenience and may apply to financial accounts including a checking function, the term is not intended to be limiting in any way and, for the purposes of determining the spirit and scope of the present disclosure, the term “checking account” is intended to refer to any financial account (including, for example, a brokerage account linked to a bank card) whether or not the financial account involves a checking function or not.

The Checking Account Protection service and method is part of a suite of identity theft protection and management services that may be offered to consumers and applies specifically to the protection of personal checking accounts. Checking accounts are often subject to theft, fraud, mis-use, and unintended exposure of personal data. Because checking accounts directly store the funds of the account owner, the urgency of providing checking account fraud related services is more acute than that for credit cards. In the event that checking account fraud occurs, including funds removed from account due to check fraud, debit and ATM card fraud, or counterfeiting, Checking Account Protection offers peace of mind to the account holder with access to Fraud Resolution Specialists, an Advancement of funds up to $25,000, and access to an online, virtual Wallet and Preventative Measures offerings.

The CAP Service can involve the participation of a dedicated Resolution Specialist to perform assisted or fully-managed restoration services on behalf of victims of Check Fraud and coordinate with Customer's applicable bank or financial institution. With assisted restoration services, the Resolution Specialist can directly advise the Customer on the best procedures and documents to respond to a Subject Checking Account Fraud Event. With fully-managed restoration services, the Resolution Specialist can serve on behalf of Customer as Customer's agent. For the Resolution Specialist to act as Customer's agent, the Customer must desirably freeze or close the affected bank account; submit to the Service Provider a Subject Checking Account Fraud case form, limited power of attorney form, and other documents as required by the Service Provider in its discretion (including copies of the original checks that were the subject of the fraud and a copy of the associated police report). In Canada, the Customer should file with the applicable banking authority a bank affidavit to report the theft associated with the Subject Checking Account Fraud and provide a certified copy of such bank affidavit; or, in the United States or its possession or territories, the Customer should file with the applicable local law enforcement authority a criminal complaint to report the theft associated with the Subject Checking Account Fraud and provide proof of the criminal complaint filed with the applicable law enforcement authority.

Advanced Advocacy Services may be provided in which the Service Provider can advance funds to Customer for Losses that Customer would later be credited to the Customer's account by its bank or financial institution, up to a total payment of $25,000 for all checking accounts to which the Service applies and within 72 hours of filing a criminal complaint, and submitting to the Service Provider all of the necessary documents as required by the Service Provider, including, but not limited to the Subject Checking Account Fraud case form.

The Customer may be offered an online, virtual Wallet, which can provide 24/7 access to password protected, encrypted secure information areas containing essential checking account and personal information the Customer wants to manage and protect including identification, contact information, credit cards, bank accounts and the like. The Wallet can help eliminate paper trail and reduce risk of fraud.

Expert Services may be offered in which, during the term of the Service, Customer can be entitled to access a Resolution Specialist who can provide support directly to Customer and timely expert advice regarding the best procedures and documents for helping to prevent and responding to a Checking Account Fraud Event.

Preventative Measures may be provided, which include best-of-industry tips to protect individuals and businesses against the many forms of fraud, as well as links to free fraud prevention and education resources.

According to an embodiment, fraud resolution is provided for all types of fraud to a checking account, which provides peace of mind to the account holder and delivers a level of service that the bank can now claim as a benefit that they are providing their customers. If fraud occurs on the account, the bank will refer their customer to a CAP service provider and the CAP service provider not only works with them and the bank to close the account and open a new one (which the bank already handles) but the CAP service provider will pursue the root cause of the fraud, and help the customer to dispute the charges and eliminate the re-occurrence of this fraud in the future. Additionally, we will help the customer determine if they could be at risk of additional fraud based on how they were exposed in this fraud incident.

In addition to the fraud resolution, the CAP system includes an advancement feature to include debit card and ATM fraud. As applied to the United States of America, the CAP system stays within the guidelines of Part 205 of the Electronic Fund Transfer Act (15 U.S.C. 1693 et seq.) (also known as “Regulation E” or “Reg E” for short), CAP service provider can advance funds up to $25,000 within 72 hours to ease the burden of the financial losses, giving the financial institution the time they need to do their investigation.

The Advancement process can require a verification of eligibility using the systems of the Service Provider; can include an inquiry as to whether the Customer has contacted the bank; can include an inquiry as to whether funds have been taken out of the account; can include an inquiry as to whether the bank reimbursed the Consumer; can include an information gathering step; can involve the sending of a resolution package in any suitable written or electronic format; can prompt the Consumer to provide details as to when and how an alleged fraud occurred; can include an inquiry as to whether a Police Report has been filed; can require a signed Affidavit; can require a Notarized, signed Affidavit; can include verification with a Financial Institution; can desirably include human review of the advancement decision; can include a means for sending an advancement to the Consumer; and can include a means for recovery of funds to the Service Provider from the Financial Institution or other appropriate entity.

As an additional value, the CAP system can include tools for fraud prevention. By creating an online account the customer will have access to preventative measures and an online Wallet provided by the CAP service provider, where the Wallet is adapted to store their checking account information in a secure environment. The subscription version of this solution also provides a one time scan of the customer checking account number, debit card number, and name and address—elements tied to that account to take proactive measures to validate their account information and ensure that the account information has not been exposed to the Internet's black market.

The present disclosure provides numerous benefits to the financial institution and consumer. For example, the financial institution is given support in fraud evaluation, is provided with a turn-key fee income opportunity and can enjoy higher levels of customer satisfaction. Also, the consumer is given peace of mind and complete protection for their checking account.

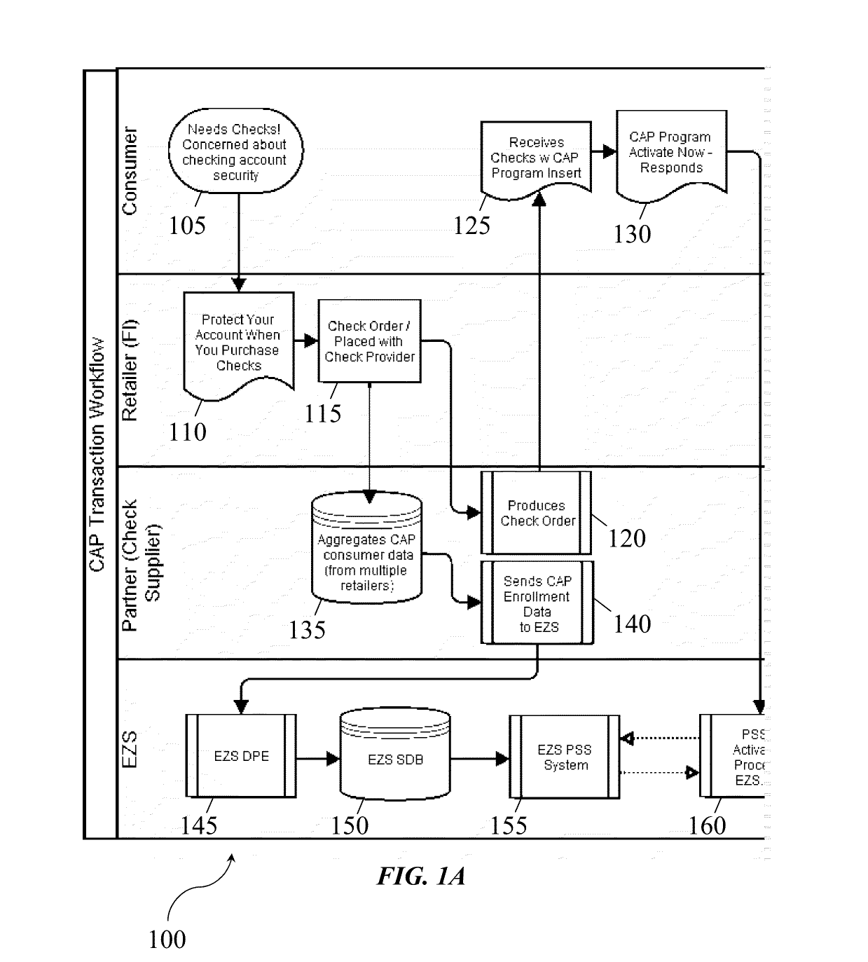

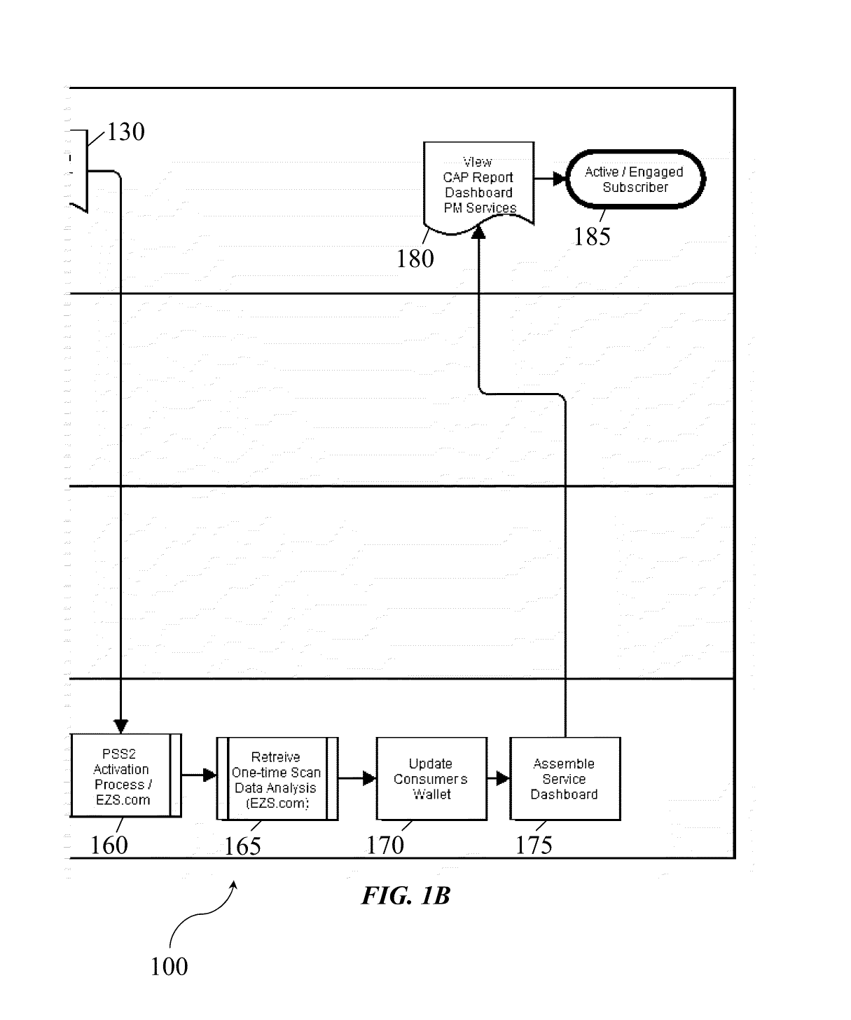

As shown, for example, in FIG. 1A and FIG. 1B, in one embodiment of the CAP system and method 100, a transactional workflow is shown, which may involve the Consumer (or Customer), a Retailer such as a Financial Institution (FI), a Partner such as a Check Supplier and a CAP service provider such as EZShield (EZS). The transaction workflow may begin when a Customer is in need of checks and is concerned about the security of their checking account 105. The Retailer may offer the Consumer an option to protect the checking account when the Consumer purchases checks for the checking account 110. The Retailer then places a check order with a Partner such as a Check Supplier (or Check Provider) 115. The Partner aggregates CAP (CAP) consumer data, which may involve one or more Retailers and then CAP enrollment data is sent by the Partner to the CAP service provider such as EZShield 135. Also, the Retailer may send a check order to the Partner 115, who produces a check order 120.

After the CAP enrollment data is sent by the Partner to the CAP service provider 140, the CAP service provider may receive the CAP enrollment data into one or more systems such as EZShield's Data Processing Engine (DPE) 145, Subscriber Database (SDB) 150 and Provisional Subscriber System (PSS) 155.

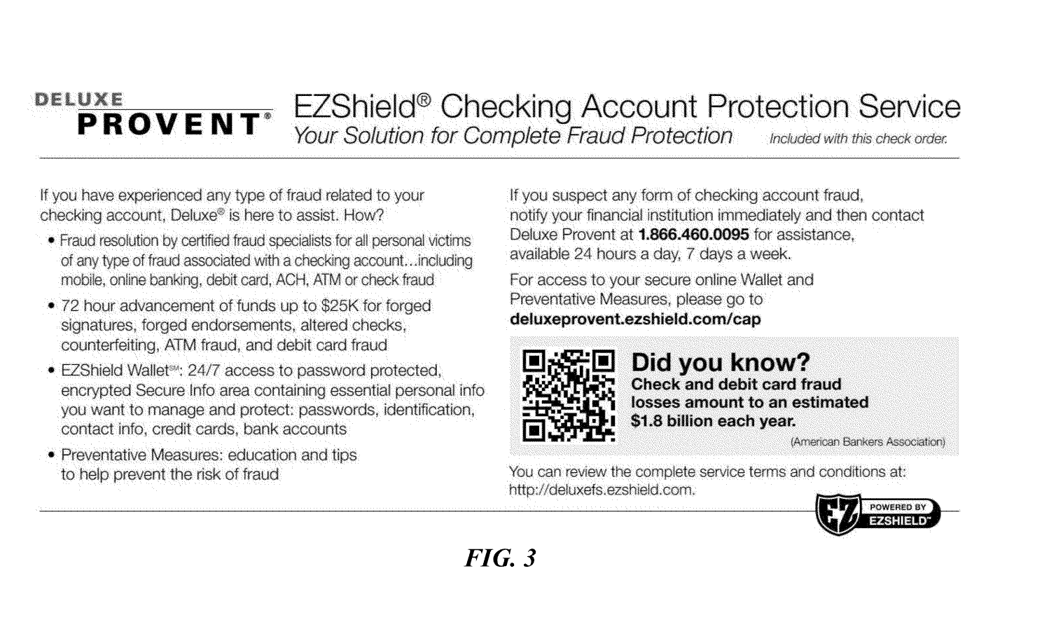

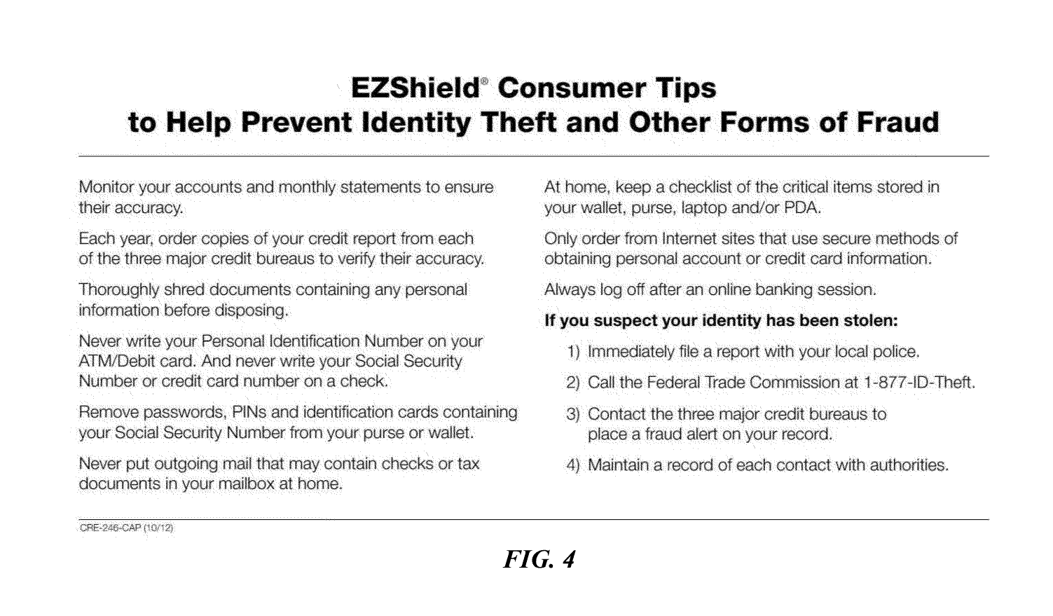

The Consumer can receive checks from the Partner with a CAP program insert 125 such as that shown in FIG. 3 and FIG. 4. After processing the CAP enrollment data, the CAP service provider can send an e-mail to the Consumer to activate the CAP subscription 160; the activation process 160 can include the exchange of data with the CAP service provider's PSS 155 and related systems such as DPE 145 and SDB 150. After receiving the checks, the Consumer can activate the CAP program by directly accessing a link provided in the insert or by responding to the e-mail sent from the CAP service provider 130.

Upon completion of the activation of the CAP program by the Consumer 160, the CAP service provider can conduct a scan of the Consumer's information and provide an analysis of the same 165. The information from the scan and analysis 165 can be used to update the Consumer's virtual Wallet 170.

Upon completion of the activation of the CAP program by the Consumer 160, the CAP service provider can assemble a Service Dashboard 175 for the Consumer, and can provide the Consumer with an ability to view the CAP Dashboard and other services as desired 180. At this point, the Consumer may be considered an active or engaged subscriber with respect to the CAP program 185.

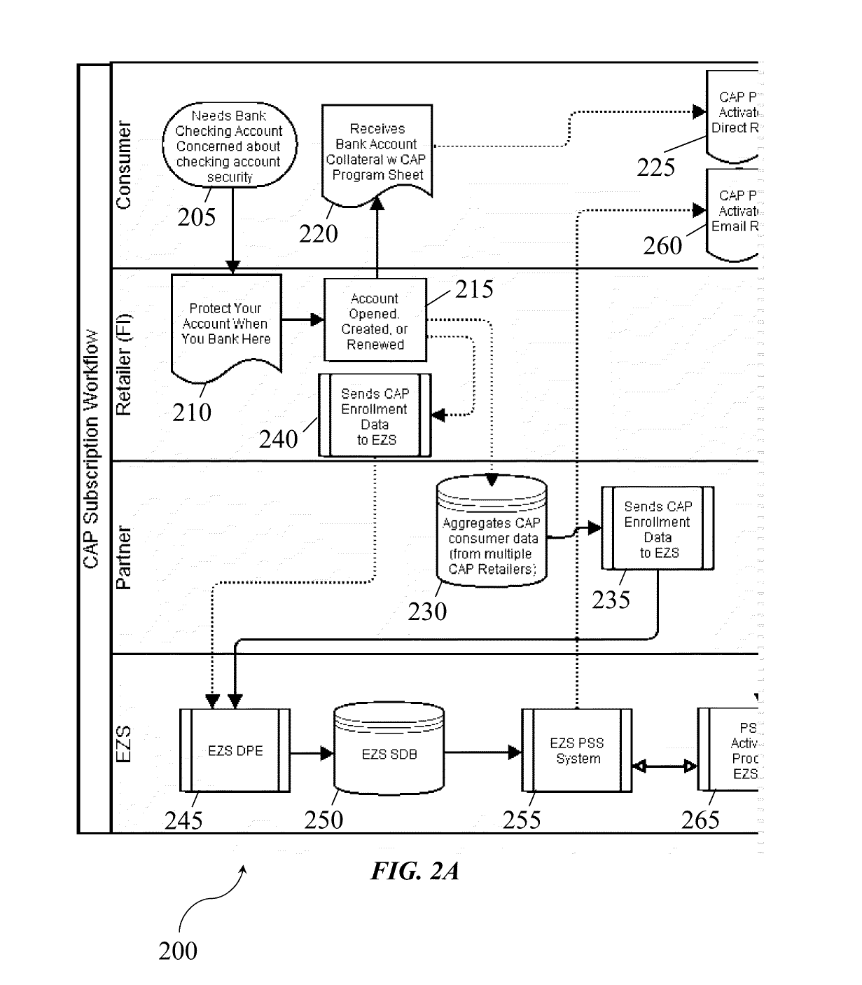

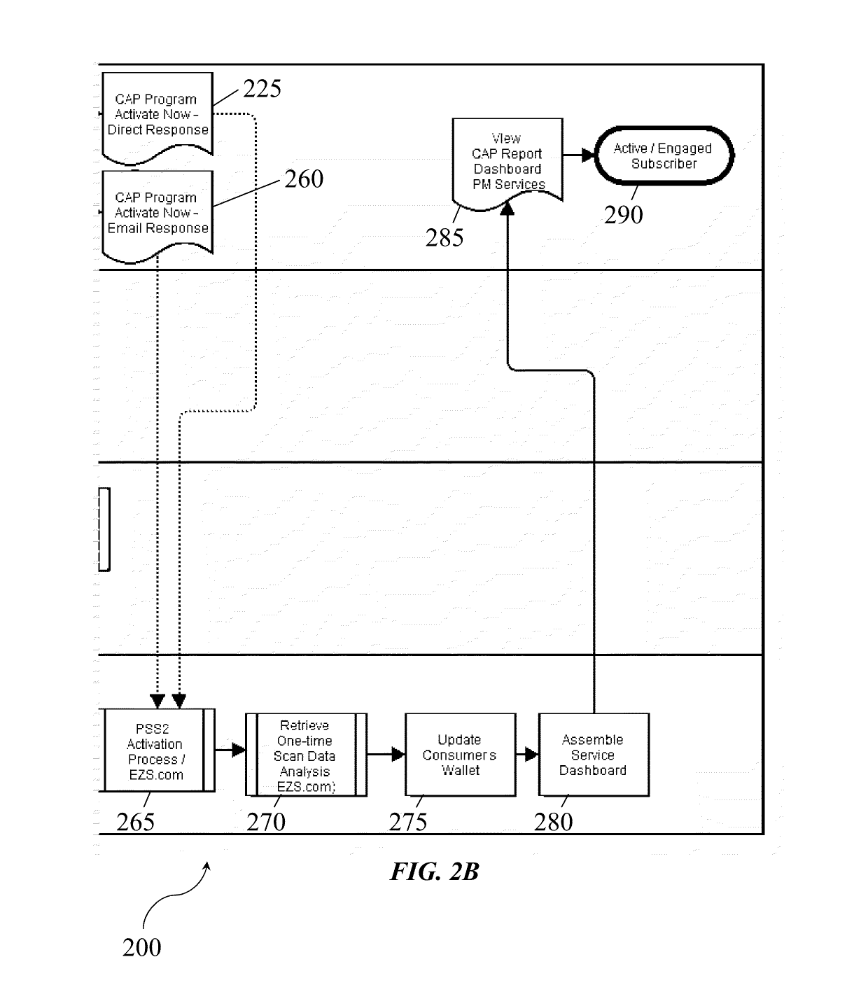

As shown, for example, in FIG. 2A and FIG. 2B, in another embodiment of the CAP system and method 200, a subscription workflow is shown, which, as with the transactional workflow, may also involve the Consumer (or Customer), a Retailer such as a Financial Institution (FI), a Partner such as a Check Supplier and a CAP service provider such as EZShield (EZS). The subscription workflow may begin when a Customer is in need of a financial account such as a bank and/or checking account and is concerned about the security of their financial account 205. The Retailer may offer the Consumer an option to protect the checking account when the Consumer opens the checking account, when visiting the bank for other reasons, when visiting the bank's website, in response to a communication or in any suitable manner 210. The Retailer opens, creates or renews an Account and then places an order with a Partner 215. The Partner aggregates CAP (CAP) consumer data, which may involve one or more Retailers 230 and then CAP enrollment data is sent by the Partner to the CAP service provider such as EZShield 235. Alternately, after the Retailer opens, creates or renews an Account and then places an order with a Retailer 215, CAP enrollment data can be sent by the Retailer to the CAP service provider such as EZShield 240.

After the CAP enrollment data is sent by the Partner to the CAP service provider 235 or by the Retailer to the CAP service provider 240, the CAP service provider may, as in the transactional workflow described above, receive the CAP enrollment data into one or more systems such as EZShield's Data Processing Engine (DPE) 245, Subscriber Database (SDB) 250 and Provisional Subscriber System (PSS) 255.

The Consumer can receive account collateral information and/or materials from the Partner with a CAP program insert 220 such as that shown in FIG. 3 and FIG. 4. After processing the CAP enrollment data, the CAP service provider can send an e-mail to the Consumer to activate the CAP subscription 265; the activation process 265 can include the exchange of data with the CAP service provider's PSS 255 and related systems such as DPE 245 and SDB 250. After receiving the account collateral information, the Consumer can activate the CAP program by directly accessing a link provided in the insert 225 or by responding to the e-mail sent from the CAP service provider 260.

Upon completion of the activation of the CAP program by the Consumer 265, the CAP service provider can conduct a scan of the Consumer's information and provide an analysis of the same 270. The information from the scan and analysis 270 can be used to update the Consumer's virtual Wallet 275.

Upon completion of the activation of the CAP program by the Consumer 265, the CAP service provider can assemble a Service Dashboard 280 for the Consumer, and provide the Consumer with an ability to view the CAP Dashboard and other services as desired 285. At this point, the Consumer may be considered an active or engaged subscriber with respect to the CAP program 290.

FIG. 3 and FIG. 4 depict examples of inserts that relate to the CAP program. The insert can include branding information, product information, taglines, service marks, trademark, copyrighted material, information regarding goods and services offered by the CAP service provider, information regarding a Partner or a Retailer, contact information relating to the CAP service provider, the Partner or the Retailer, a link to activate a CAP transaction or subscription, consumer tips relating to identity theft prevention and fraud prevention and related information.

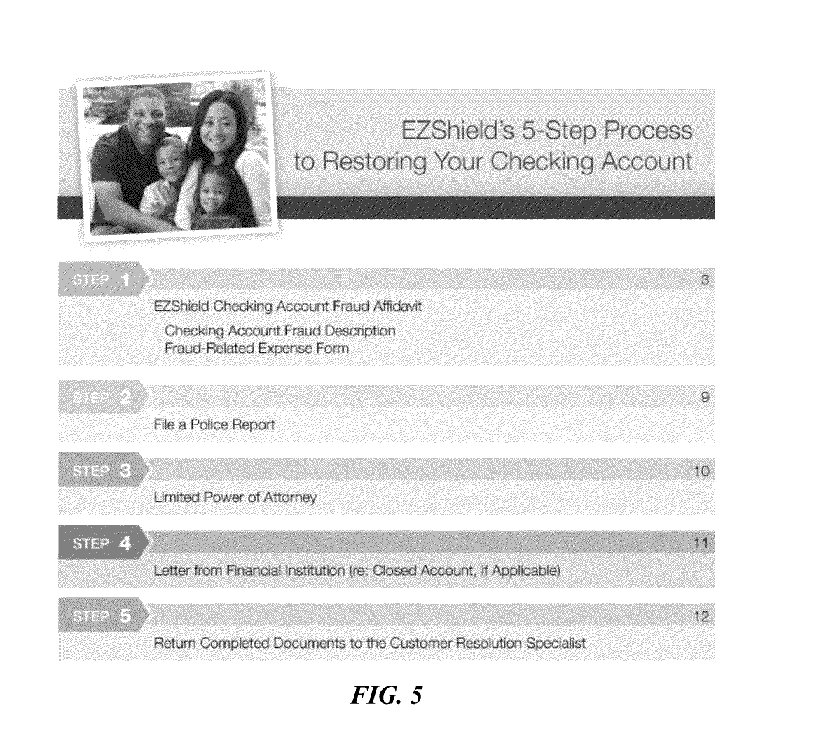

FIG. 5 depicts a flow chart including an example of a method for restoring a checking account protected by the CAP system and method according to an embodiment. According to an embodiment, the Consumer may be advised to provide requested information to a Resolution Specialist working for the CAP service provider in a timely manner; to complete certain basic tasks or actions to facilitate the Checking Account Protection process; to abide by all regulations, federal and state laws throughout the Checking Account Protection process; close the affected checking account that had fraud, or that is at risk for fraud, if applicable; and assist in getting Checking Account Protection receipts showing old and new check orders.

The Checking Account Protection process may be limited, for example, to checks drawn from a bank account identified in an order. Advanced advocacy services may apply only if the facts alleged in Customer's police report indicate that Customer has a valid request for the advanced funds under the UCC, Reg E, and the Customer does not misrepresent such facts. If Customer is paid by the Checking Account Protection service provider for the Losses and paid a second time for the Losses by the Customer's applicable bank or financial institution, Customer may be asked to hold the second payment as an agent for the Checking Account Protection service provider and deliver such funds to the Checking Account Protection service provider as directed by the Checking Account Protection service provider. Losses may arise from fraud involving a checking account at a bank domiciled in the United States or its territories or Canada and must be reported to law enforcement authorities as evidenced by a police report in the United States, or a bank affidavit in Canada. The Checking Account Protection service provider may reserve the right to not advance funds to any Customer for any Losses incurred by Customer as a result of any Subject Check Fraud perpetrated by (i) Customer, (ii) any employee or agent of Customer and/or any other person who is a joint account holder with Customer, and (iii) any Affiliated Persons unless a police report is filed against the Affiliated Person who was the perpetrator of the Subject Check Fraud. The Checking Account Protection service provider may not advance funds to any Customer for any Losses incurred by Customer as a result of any Subject Checking Account Fraud where: (i) Customer's failure to exercise ordinary care substantially contributed to the Subject Checking Account Fraud; or (ii) Customer is fooled by an imposter. The Checking Account Protection service provider reserves the right, at its sole discretion, to collect from the Customer any portion of the funds that Customer had requested in the event that Customer's bank or financial institution does not reimburse Checking Account Protection service provider for any portion of Customer's Losses. Losses can include those funds debited due to fraud from counterfeit checks, debit and ATM card fraud. The Checking Account Protection service can apply only to all named individuals on a checking account and not to businesses. The Checking Account Protection service provider may not be required to pay for any Losses unless Customer provides to Checking Account Protection service provider the properly completed documentation requested by Checking Account Protection service provider reasonably promptly and, in any event, on or before the earlier of thirty (30) days after (i)

Customer discovering the Subject Checking Account Fraud; and (ii) Customer being provided with the bank statement reflecting, or the original or a copy of the check that is the subject of the Subject Checking Account Fraud; or the time period for which Customer's financial institution requires the reporting of check fraud.

The method depicted in FIG. 5 may comprise one or more of the following steps.

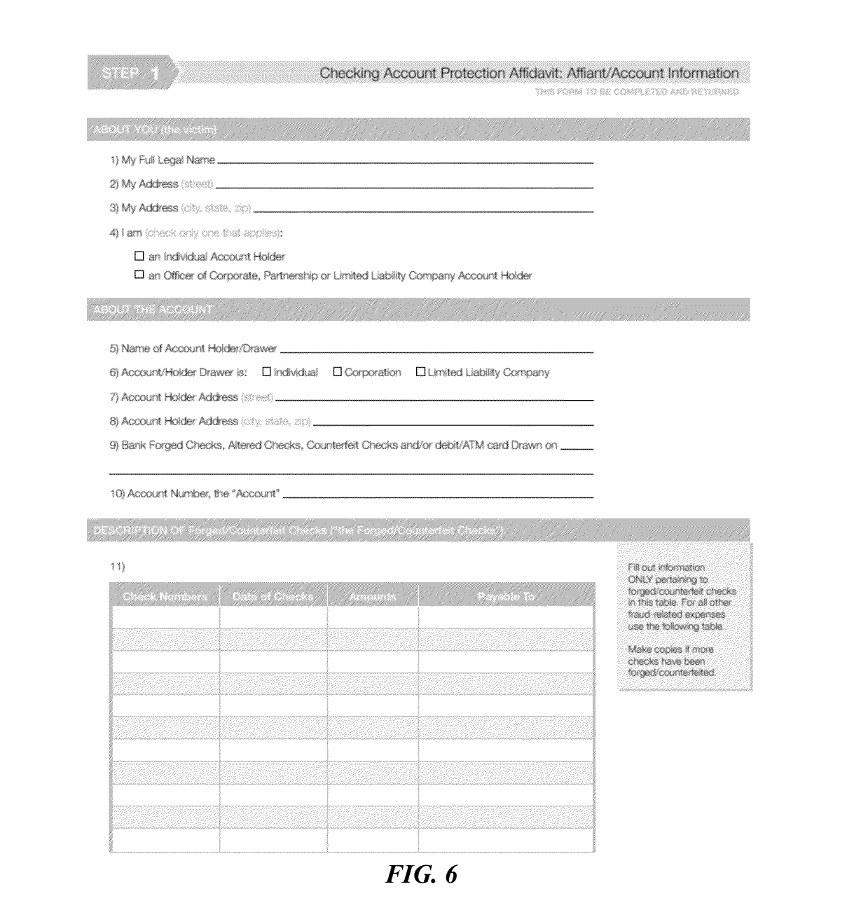

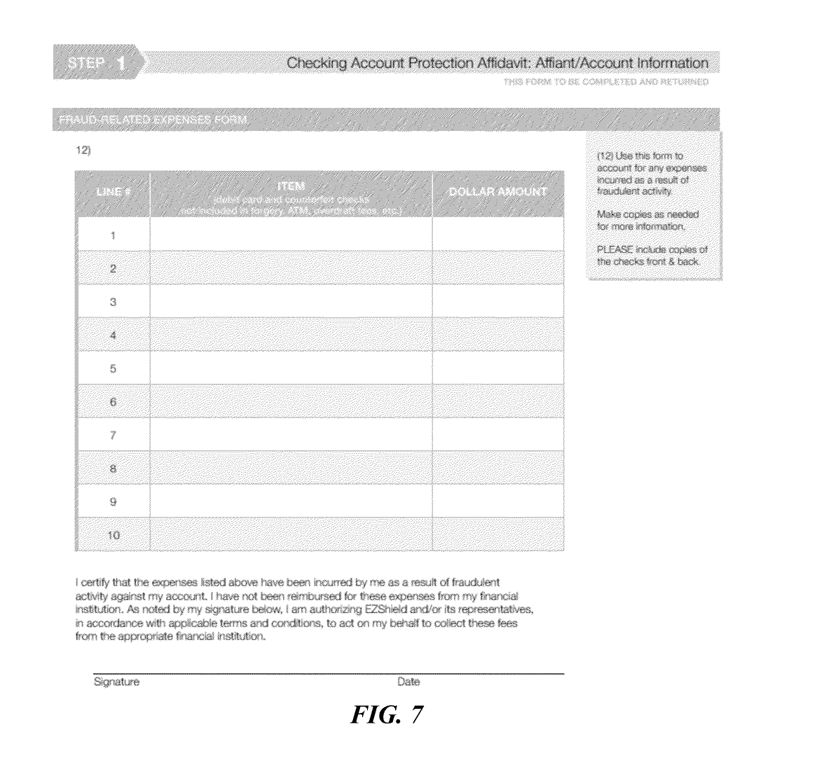

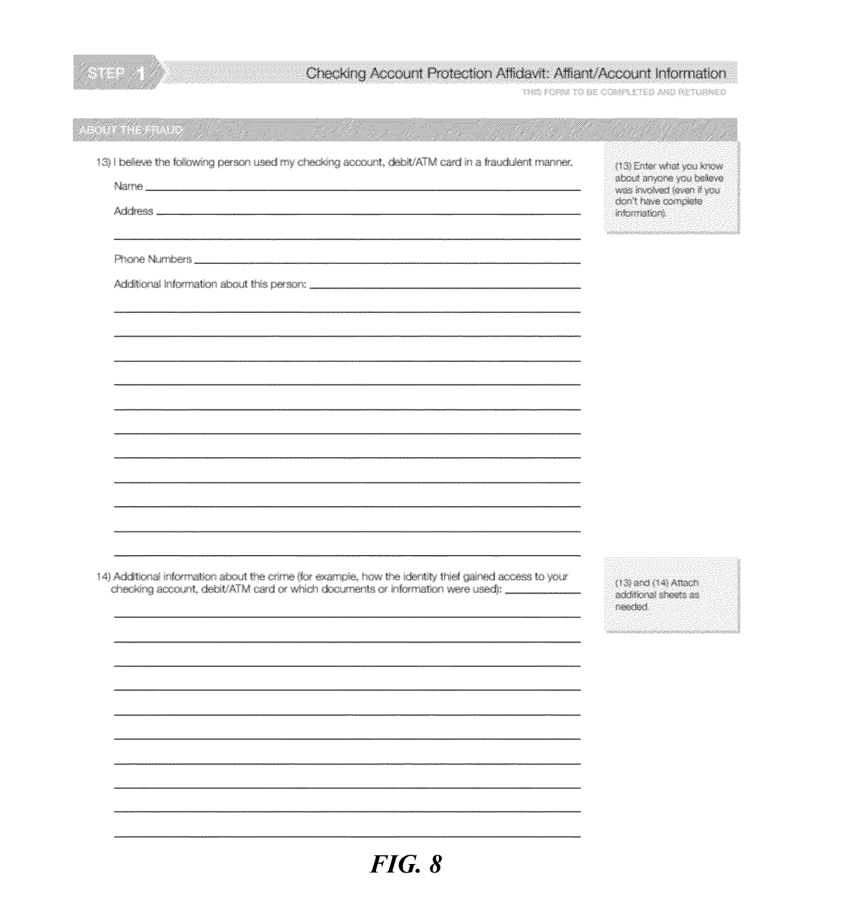

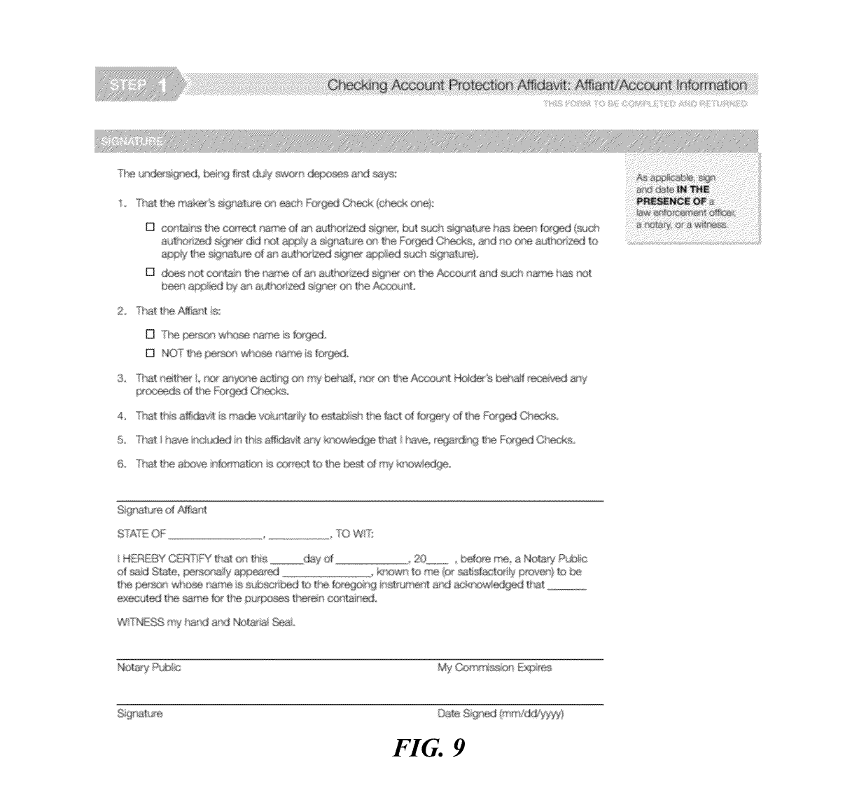

Step 1: Complete a Checking Account Fraud Affidavit including a Checking Account Fraud Description and a Fraud-Related Expense Form. Step 1 can include a prompt for a Customer to provide information, which may include completion of one or more of the following: a checking account fraud or protection affidavit, such as that depicted in FIG. 6, which may include information about the Customer, the account and a description of forged/counterfeit checks, information regarding the affiant and/or the affiant's account, such as that depicted in FIG. 7, which may include a fraud-related expenses form and a space for certification, signature and date, information regarding the fraud, such as that depicted in FIG. 8, and a signature page, such as that depicted in FIG. 9, which may include sworn statements, a block for a Notary Public or suitable public official to witness the Customer's signature, signature blocks and the like.

To ensure that the Customer does not become responsible for any debts incurred by an identity thief, the Customer can be prompted to prove to each of the companies (for example, through which the Customer opened accounts in the Customer's name) that the Customer did not create the debt. An identity theft Affidavit is provided to make it easier for fraud victims to report information. This affidavit can consist of two parts: 1) an Identity Theft Declaration/Checking Account Fraud, where the Customer can report general information about the Customer and the theft; and 2) a Fraud Incident Report, where the Customer can describe the fraudulent account(s) opened in the Customer's name. The customer can use a separate fraud incident report for all companies where there is a transaction in question.

Before sending your affidavit to the CAP service provider, the Customer can be prompted to review the disputed account(s) with family members or friends who may have information about the account(s) or access to them.

The Customer may be prompted to include photocopies (not originals) of any supporting documentation that the Customer can provide.

The Customer can be required to sign the affidavit in front of a Notary Public in order to make the affidavit valid.

The information the Customer provides can, if desired, be used only by the company that processes your affidavit, investigates the events you report, and helps stop further fraud. If this affidavit is requested in a lawsuit, the company may have to provide it to the requesting party.

The Customer may be advised that completing this affidavit does not guarantee prosecution of the identity thief, nor clearance of the debt.

Step 2: Prompt the Customer to file a Police Report. As part of Step 2, the Customer may be advised that filing an identity theft police report is one of the first steps the Customer should take when the Customer has discovered any indication of identity theft and/or checking account fraud. The Customer may also be advised that the Customer may need this report to validate and document that the Customer is a victim of identity theft and/or checking account fraud. The Customer may further be advised that many of the fraud departments the Customer will be in contact with will request a copy of a police report. The Customer may be advised that procedures vary by jurisdiction, but there are usually several options for filing a police report. Many police departments let you file the police report on their website. Others police department let you file over the phone or in person. Some cities may send a police officer to your residence.

The Customer may be advised that if you are a victim of identity theft and/or checking account fraud then contact the police department in the city where the crime occurred; talk to a police officer as soon as possible after the crime took place so the Customer's memory of the incident and individuals involved is fresh; and the Customer can amend the police report to reflect any new information the Customer obtains as it relates to the Customer's case.

The Customer may be prompted to request a copy of the Customer's police report and document the case number assigned to the same. The Customer may be advised to refer to the number when the Customer wants an update on the Customer's case.

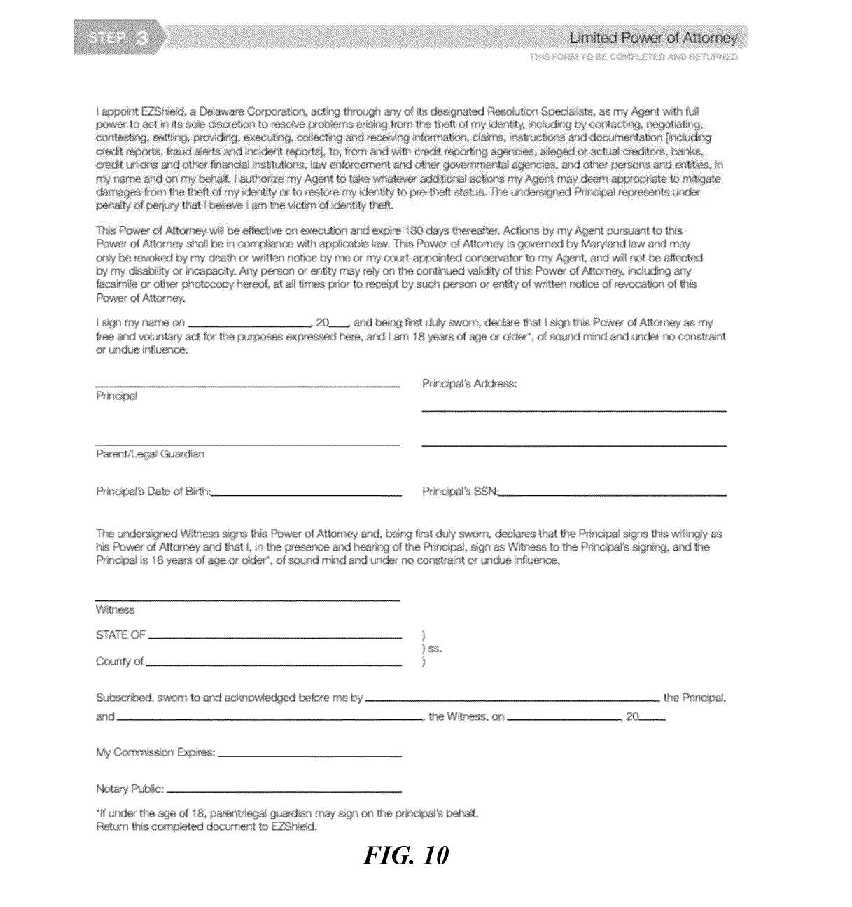

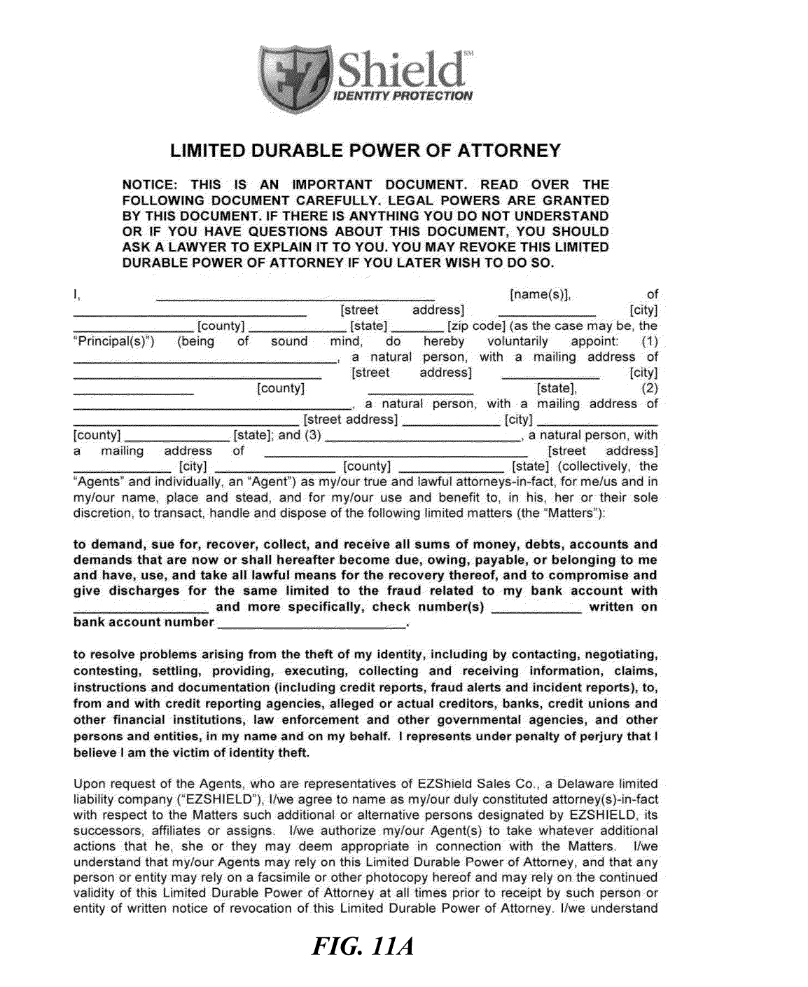

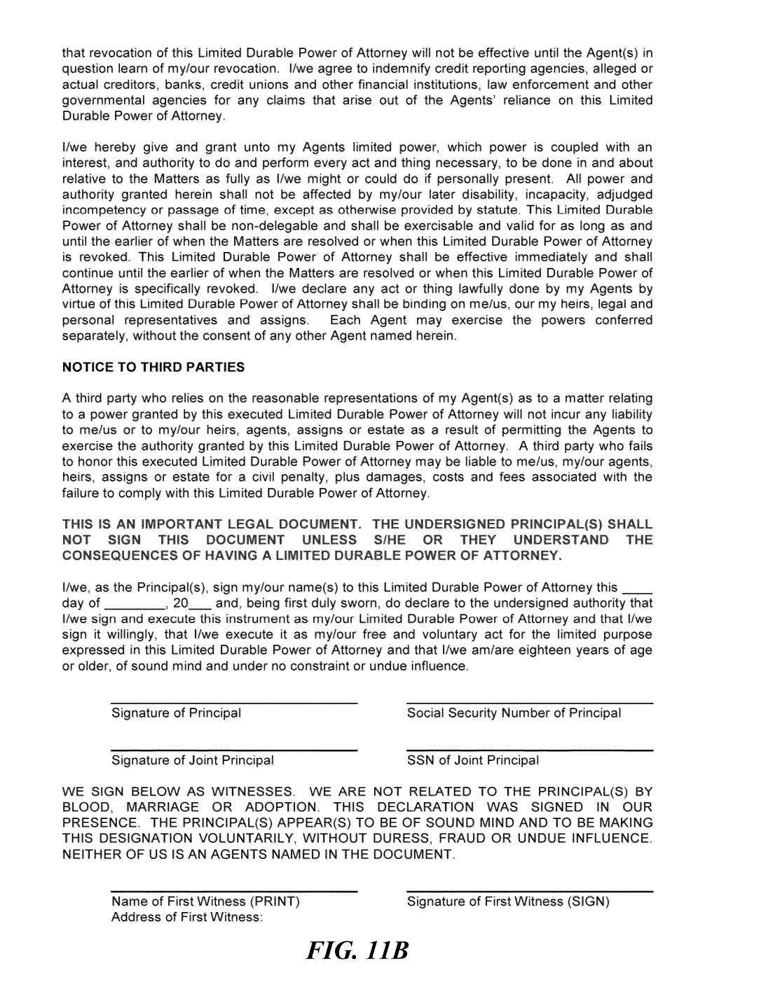

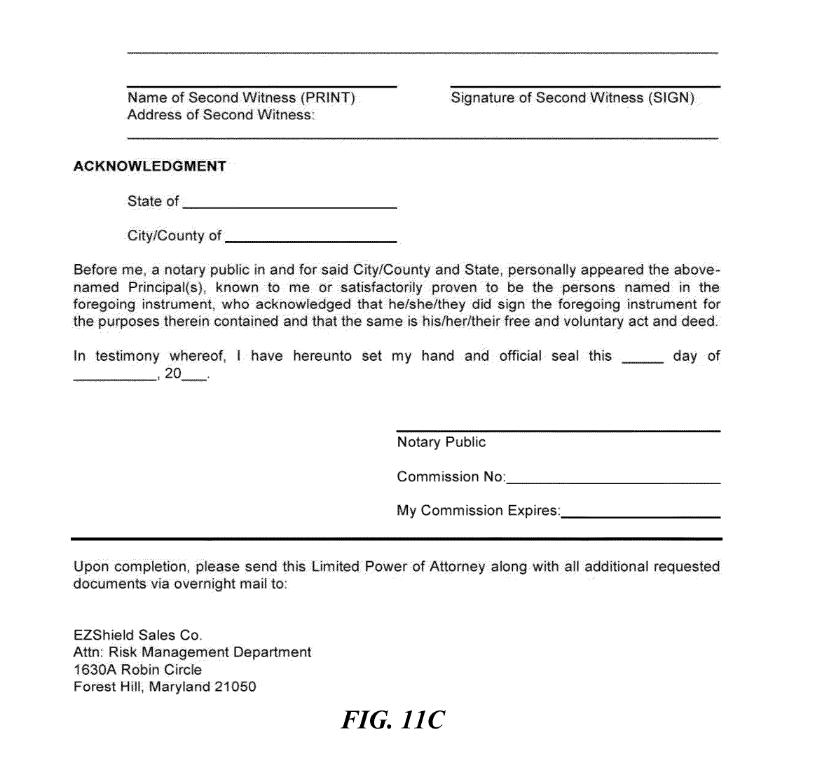

Step 3: Execute a legal document such as a Limited Power of Attorney such as that shown in FIG. 10, or in FIG. 11A, FIG. 11B and FIG. 11C.

Step 4: Close the Account and send a copy of a letter from the Financial Institution. Step 4 may include advising the Customer that to thwart further damages, the Customer's checking account at the Customer's financial institution should be closed; may further advise mailing a copy of the letter from the Customer's financial institution along with the items discussed in Steps 1-3. The Customer may further be advised that it will be best to open a new account for the Customer's new checks or financial instruments.

Step 5: Return Completed Documents to a Customer Resolution Specialist working with the CAP service provider. The Customer may be advised to return, for example, one or more of the following: a Forgery Affidavit, a Checking Account Fraud Affidavit, a Checking Account Fraud Description, a Copy of a Completed Police Report, Copies of Bank Statements which detail fraudulent activity/charges, Copies of Forged, Altered and/or Counterfeited checks (front and back), a Signed Limited Power of Attorney, and a Letter from Financial Institution With Closed Account Info. The Customer may be advised to print clearly on forms intended for manual completion. The Customer may be advised to mail or fax the completed affidavit forms with any additional requested documents.

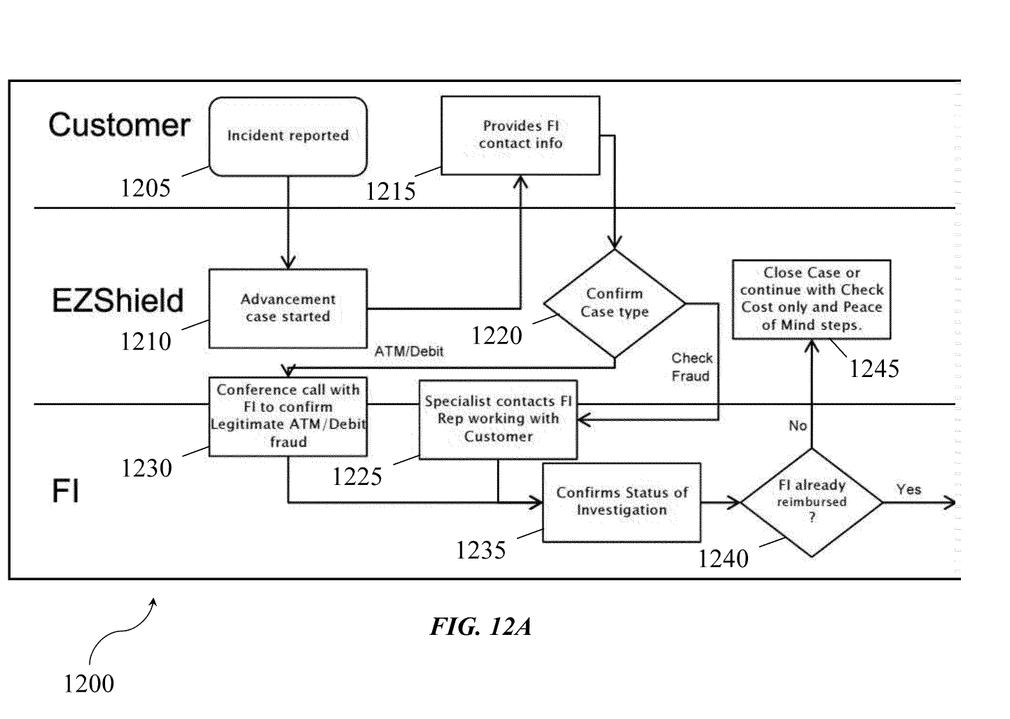

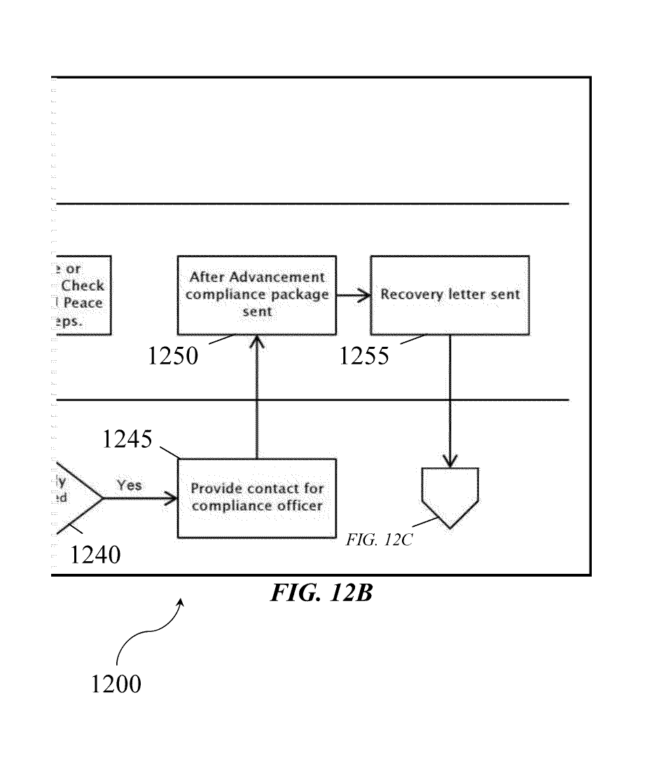

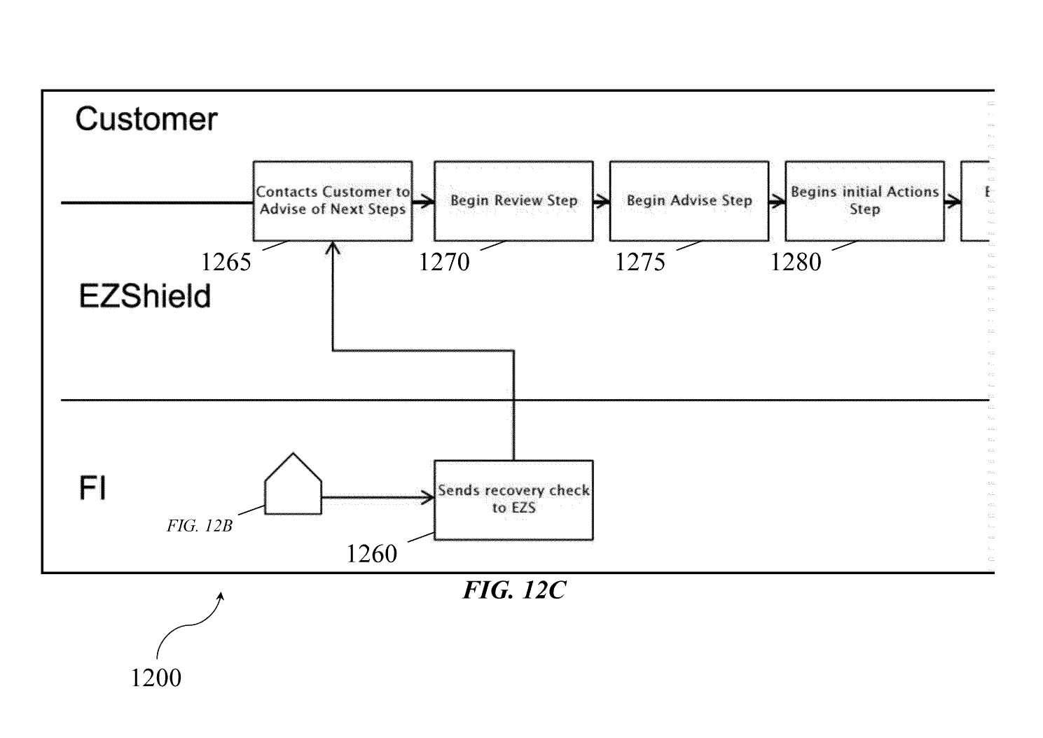

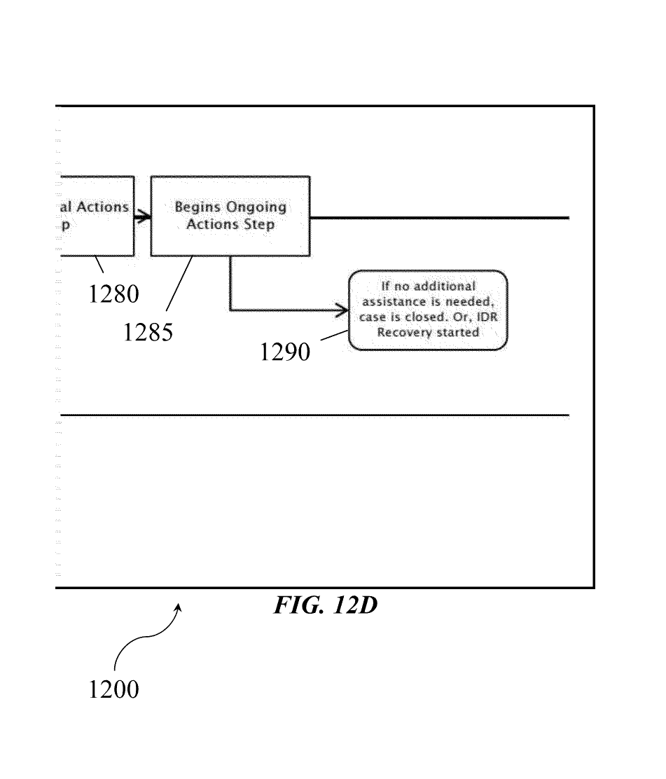

FIG. 12 depicts a flow chart for a Checking Account Protection Advancement process 1200 in accordance with an embodiment, where FIG. 12A is a first portion of the flow chart, FIG. 12B is a second portion of the flow chart, FIG. 12C is a third portion of the flow chart and FIG. 12D is a fourth portion of the flow chart. The Checking Account Protection Advancement process 1200 can include at least one or more of the steps described below.

After completing the process depicted, for example, in FIG. 1 or FIG. 2, a Customer can report a suspected fraud incident to the CAP service provider 1205. The CAP service provider can start an Advancement case 1210. The Customer can be asked to provide one or more pieces of information relating to the suspected fraud incident. Either before or after the suspected fraud incident, the Customer can be provided with information including, for example, an overview of the CAP process such as that shown in FIG. 5; a checking account fraud or protection affidavit such as that shown in FIG. 6; a fraud-related expenses form such as that shown in FIG. 7; a form for collecting information regarding the fraud such as that shown in FIG. 8; a signature page which may include sworn statements, a block for a Notary Public or suitable public official to witness the Customer's signature, signature blocks and the like such as that shown in FIG. 9; and a legal document such as a Limited Power of Attorney, such as that shown in FIG. 10, and, separately, in FIG. 11A, FIG. 11B and FIG. 11C.

After the advancement case is started 1210, the CAP service provider can prompt the Customer to provide financial institution contact (FI) information 1215. Upon receipt of the financial institution contact (FI) information 1215 from the Consumer, the CAP service provider can confirm the type of suspected fraud 1220. For example, the type of suspected fraud can be check fraud or a fraud related to an ATM or debit card. If the type of suspected fraud is check fraud, then a Specialist with the CAP service provider can contact a representative of the financial institution working with the Customer 1225. If the type of suspected fraud is a fraud related to an ATM or Debit card, then a Specialist with the CAP service provider can arrange a conference call with a representative of the financial institution working with the Customer in order to confirm whether the suspected fraud is a legitimate ATM or debit card fraud 1230. After the Specialist with the CAP service provider contacts the representative of the financial institution working with the Customer 1225 or after arranging the conference call with the representative of the financial institution working with the Customer in order to confirm whether the suspected fraud is a legitimate ATM or debit card fraud 1230, the financial institution can confirm the status of an investigation related to the fraud 1235.

After the investigation is complete, if the financial institution was not already reimbursed 1240, then the CAP service provider can close the case or continue with other actions to support the customer such as actions relating to the cost of the check or steps to give the customer peace of mind 1245.

After the investigation is complete, if the financial institution was already reimbursed 1240, then the financial institution can provide contact information for a compliance officer 1245. After information for the compliance officer is provided to the CAP service provider, an Advancement compliance package 1250 and a recovery letter 1255 can be sent by the CAP service provider, and the financial institution can send a recovery check to the CAP service provider 1260.

After receipt of the recovery check from the financial institution, the CAP service provider can contact the Customer to advise the Customer of next steps in the process 1265, begin a review process 1270, begin providing advice to the Customer 1275, begin initial actions 1280 and begin ongoing actions 1285. After completion of all required communications between the Customer and the CAP service provider, if no additional assistance is needed, the case can be closed by the CAP service provider, or an identity restoration (IDR) recovery process can be started 1290.

The Checking Account Protection Advancement process 1200 can, at any suitable time, further include one or more of the following steps related to Advancement Approval, Escalation of Approval, Advancement Processing and Recovery of Funds (with respect to the Bank or Financial Institution and/or with respect to the Customer), examples of which are described in greater detail below.

Advancement Approval. Once a packet or information is returned or provided to the CAP service provider by the Customer, the CAP service provider can ensure all required information or documentation has been included and is fully complete. Once confirmed, the CAP service provider can update the Customer's case using a fraud tracking system and update a checklist relating to the CAP service. The CAP service provider can contact the Customer and advise that packet has been received and will be reviewed, which can initiate the start of a 72 hour timeframe. The CAP service provider can verify with the Customer's bank that funds have not been returned to the Customer. If the bank will not verify, then the CAP service provider can ask the Customer if they would be willing to conduct a conference call the bank with the Specialist of the CAP service provider. Before ending this call, the CAP service provider can request that the bank provide contact information for their Compliance Officer. The ability to verify return of funds by the Customer's bank does not necessarily delay potential approval of advancement to the Customer.

If packets are not returned within a specified period of time, such as two business weeks, the CAP service provider can require an inquiry with the Customer to determine whether the packet will be returned. If the Customer indicates an advancement request will not be submitted, then the CAP service provider can note the Customer's case in the fraud tracking system and close the case. If the Customer will be submitting an advancement request, the CAP service provider can note the Customer's case in the fraud tracking system. If, after a second specified period of time, such as two business weeks, the packet is still not returned, the CAP service provider can again contact the Customer, and the CAP service provider can place a comment on the Customer's case in the fraud tracking system. If the packet is still not received after another specified period of time, such as two business weeks, then the CAP service provider can close the case in the fraud tracking system and notate the case accordingly.

Escalation of Approval. If the advancement request is over a specified amount, for example, over $500.00 for a personal case or over $1,000.00 for a business case, the entire packet can be forwarded to a higher-level reviewer within the CAP service provider's organization for further review and to request necessary approvals, which can include, for example, a Chief Operating Officer or Legal Counsel.

Advancement Processing. Once the advancement is approved, a Specialist for the CAP service provider can request a check through an appropriate financial unit with the CAP service provider. The CAP service provider can complete a Check Request Form, including the full case packet, the advancement checklist and submit to appropriate personnel for approval. The CAP service provider can contact the Customer to verify that someone will be available to sign for the delivery. Upon receipt of the check from the appropriate department, the CAP service provider can mail the check, a Customer testimonial form, a return envelope and a gift card via an appropriate delivery service, which can include an overnight delivery and which can include a signature requirement. The CAP service provider can track the package to verify delivery within a specified timeframe, which can be, for example, 72 hours. Upon delivery notification, the CAP service provider can contact the Customer for delivery confirmation. The CAP service provider can update or document the Customer's case in the fraud tracking system.

Recovery of Funds—Bank. After the CAP service provider sends the advancement check to the Customer (for example, within one day), the CAP service provider can send a letter via certified mail to the bank requesting that funds be reimbursed to the CAP service provider on behalf of the Customer. After a specified period of time, for example, after two business days, and after the Specialist for the CAP service provider has received confirmation that a bank contact has signed for the letter, the Specialist can call the bank to discuss reimbursement. If funds are not sent by the bank, then the CAP service provider can send a second letter (for example, one month from the date the first letter was sent) to the bank via a suitable method, for example via certified mail, requesting funds. If funds are still not sent after two weeks from when the second letter was sent, the CAP service provider can forward the case information to a higher-level official within the CAP service provider to determine next steps, which can include, if appropriate, litigation. If or when funds are recovered, the CAP service provider can send the check to the appropriate department within the CAP service provider to be deposited and notate the case in the fraud tracking system to confirm the funds have been recovered.

Recovery of Funds—Customer. If after sending an advancement check to the Customer, the CAP service provider becomes aware the Bank has also replaced the funds in the Customer's account, then the CAP service provider can advise the Customer that the funds shall be delivered to the CAP service provider. If the Customer does not comply with the request, then the Specialist can forward the case with details to a higher-level official within the CAP service provider to determine next steps which can include one or more of the following: Creation of a Demand for Reimbursement letter to be sent to the Customer via suitable communication method, which can include email and certified mail; Creation of a Debt Agreement Contract to be sent to the Customer via suitable communication method; and/or the CAP service provider can continue to follow up with the Customer via suitable communication method on a regular basis in an effort to recover funds.

The present invention is directed, for example, to a computer implemented method for protecting a customer's financial account from fraud and for reimbursing the customer's financial account in the event of fraud, comprising: on a device having one or more processors and a memory storing one or more programs for execution by the one or more processors, the one or more programs including instructions for: determining whether the customer is eligible for an advancement of funds associated with a loss from the customer's financial account, wherein the loss is associated with a fraud event; sending the advancement from a financial account protection service provider to the customer; and recovering funds associated with the advancement from a financial institution associated with the customer's financial account to the financial account protection service provider.

The financial account protection service provider can manage information associated with the customer using at least one system from the group consisting of a data processing engine system, a subscriber database system and a provisional subscriber system.

The determining step can comprise: inquiring as to whether the customer has contacted a financial institution responsible for managing the customer's financial account; inquiring as to whether funds have been taken out of the financial account; and inquiring as to whether the financial institution has reimbursed the customer.

The determining step can comprise: sending a resolution package to the customer; and prompting the customer to provide details as to when and how an alleged fraud occurred.

The determining step can comprise: inquiring as to whether a police report has been filed; prompting the customer to sign an affidavit; and prompting the customer to notarize the signed affidavit.

The determining step can comprise: verifying information received from the customer with the financial institution.

The computer implemented method can further comprise: prompting the customer to complete a checking account fraud affidavit including a checking account fraud description and a fraud-related expense form; prompting the customer to file a police report; prompting the customer to execute a legal document; closing the financial account with the financial institution; and prompting the customer to return completed documents to the provider.

The legal document can be a limited power of attorney.

The fraud event can comprise mobile, online or offline fraud associated with the financial account including funds removed from the financial account due to check fraud, debit and automated teller machine (ATM) card fraud or counterfeiting.

The method can be compliant with Part 205 of the Electronic Fund Transfer Act and Uniform Commercial Code requirements for disputed transactions.

The computer implemented method can further comprise scanning the customer's financial account.

The computer implemented method can further comprise granting the customer access to an online, virtual wallet.

The customer can be prompted to enroll in a financial account protection service managed by the financial account protection service provider as part of a system for ordering checks associated with the financial account.

The customer can be prompted to enroll in a financial account protection service managed by the financial account protection service provider as part of a system for opening or renewing the financial account.

The computer implemented method can further comprise providing the customer with a list of preventative measures.

Also, the present invention is directed, for example, to a computer system for protecting a customer's financial account from fraud and for reimbursing the customer's financial account in the event of fraud, comprising: one or more processors; and memory to store: one or more programs, the one or more programs comprising instructions for: determining whether the customer is eligible for an advancement of funds associated with a loss from the customer's financial account, wherein the loss is associated with a fraud event; sending the advancement from a financial account protection service provider to the customer; and recovering funds associated with the advancement from a financial institution associated with the customer's financial account to the financial account protection service provider.

Further, the present invention is directed, for example, to a non-transitory computer-readable storage medium storing one or more programs configured to be executed by one or more processing units at a computer comprising instructions for: determining whether a customer is eligible for an advancement of funds associated with a loss from the customer's financial account, wherein the loss is associated with a fraud event; sending the advancement from a financial account protection service provider to the customer; and recovering funds associated with the advancement from a financial institution associated with the customer's financial account to the financial account protection service provider.

Although some of various drawings illustrate a number of logical stages in a particular order, stages which are not order dependent can be reordered and other stages can be combined or broken out. Alternative orderings and groupings, whether described above or not, can be appropriate or obvious to those of ordinary skill in the art of computer science. Moreover, it should be recognized that the stages could be implemented in hardware, firmware, software or any combination thereof. While specific values, relationships, materials and steps have been set forth for purposes of describing concepts of the present disclosure, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth embodiments and certain modifications of the concept underlying the present disclosure, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A computer implemented method for protecting a customer's financial account from fraud and for reimbursing the customer's financial account in the event of fraud, comprising:
on a device having one or more processors and a memory storing one or more programs for execution by the one or more processors, the one or more programs including instructions for:
determining whether the customer is eligible for an advancement of funds associated with a loss from the customer's financial account, wherein the loss is associated with a fraud event;
sending the advancement from a financial account protection service provider to the customer; and
recovering funds associated with the advancement from a financial institution associated with the customer's financial account to the financial account protection service provider.

2. The computer implemented method of claim 1, wherein the financial account protection service provider manages information associated with the customer using at least one system from the group consisting of a data processing engine system, a subscriber database system and a provisional subscriber system.

3. The computer implemented method of claim 1, wherein the determining step comprises:
inquiring as to whether the customer has contacted a financial institution responsible for managing the customer's financial account;
inquiring as to whether funds have been taken out of the financial account; and
inquiring as to whether the financial institution has reimbursed the customer.

4. The computer implemented method of claim 1, wherein the determining step comprises:
sending a resolution package to the customer; and
prompting the customer to provide details as to when and how an alleged fraud occurred.

5. The computer implemented method of claim 1, wherein the determining step comprises:
inquiring as to whether a police report has been filed;
prompting the customer to sign an affidavit; and
prompting the customer to notarize the signed affidavit.

6. The computer implemented method of claim 1, wherein the determining step comprises:
verifying information received from the customer with the financial institution.

7. The computer implemented method of claim 1 further comprising:
prompting the customer to complete a checking account fraud affidavit including a checking account fraud description and a fraud-related expense form;
prompting the customer to file a police report;
prompting the customer to execute a legal document;
closing the financial account with the financial institution; and
prompting the customer to return completed documents to the provider.

8. The computer implemented method of claim 7, wherein the legal document is a limited power of attorney.

9. The computer implemented method of claim 1, wherein the fraud event comprises mobile, online or offline fraud associated with the financial account including funds removed from the financial account due to check fraud, debit and automated teller machine (ATM) card fraud or counterfeiting.

10. The computer implemented method of claim 1, wherein the method is compliant with Part 205 of the Electronic Fund Transfer Act and Uniform Commercial Code requirements for disputed transactions.

11. The computer implemented method of claim 1 further comprising scanning the customer's financial account.

12. The computer implemented method of claim 1 further comprising granting the customer access to an online, virtual wallet.

13. The computer implemented method of claim 1, wherein the customer is prompted to enroll in a financial account protection service managed by the financial account protection service provider as part of a system for ordering checks associated with the financial account.

14. The computer implemented method of claim 1, wherein the customer is prompted to enroll in a financial account protection service managed by the financial account protection service provider as part of a system for opening or renewing the financial account.

15. The computer implemented method of claim 1 further comprising providing the customer with a list of preventative measures.

16. A computer system for protecting a customer's financial account from fraud and for reimbursing the customer's financial account in the event of fraud, comprising:
one or more processors; and
memory to store:
one or more programs, the one or more programs comprising instructions for:
determining whether the customer is eligible for an advancement of funds associated with a loss from the customer's financial account, wherein the loss is associated with a fraud event;
sending the advancement from a financial account protection service provider to the customer; and
recovering funds associated with the advancement from a financial institution associated with the customer's financial account to the financial account protection service provider.

17. A non-transitory computer-readable storage medium storing one or more programs configured to be executed by one or more processing units at a computer comprising instructions for:
determining whether a customer is eligible for an advancement of funds associated with a loss from the customer's financial account, wherein the loss is associated with a fraud event;
sending the advancement from a financial account protection service provider to the customer; and
recovering funds associated with the advancement from a financial institution associated with the customer's financial account to the financial account protection service provider.
